(19) United States
(12) Patent Application Publication
(10) Pub. No.: US 2026/0359720 A1
(43) Pub. Date: Nov. 12, 2026

(54) TEACHING LANGUAGE MODELS TO THINK AGENTICALLY USING CHAINS OF EDITS

(71) Applicant: QUALCOMM Incorporated, San Diego, CA (US)

(72) Inventors: Corrado RAINONE, Haarlem (NL); Tim Boudewijn BAKKER, Amsterdam (NL); Michael DEFFERRARD, Chavannes-sous-Orsonnens (CH); Roland MEMISEVIC, Toronto (CA)

(21) Appl. No.: 19/337,393

(22) Filed: Sep. 23, 2025

Related U.S. Application Data
(60) Provisional application No. 63/803,623, filed on May 10, 2025.

(51) Int. Cl. G06N 20/00; G06F 8/30

(52) U.S. Cl. CPC G06N 20/00; G06F 8/31

(57) ABSTRACT

Techniques and apparatus for program code synthesis using machine learning are provided. In an example method, an input including program code with first content is accessed, code is repaired based on processing the input, and the repaired code is output. Repairing the code generally includes sending the code with the first content from the model to a text editor for execution of the code with the first content; receiving, from the editor, an indication of a first state of the code, the first state comprising the first content of the code and first feedback from the execution of the code with the first content; and based on processing the first feedback using the model, sending a first editing command to the text editor for modifying the code with the first content.

### CROSS-REFERENCE TO RELATED APPLICATION(S)

The present application for patent claims the benefit of priority to U.S. Provisional Patent Application No. 63/803,623, filed May 10, 2025, which is hereby incorporated by reference herein in its entirety for all applicable purposes.

### INTRODUCTION

Aspects of the present disclosure relate to machine learning.

A wide variety of machine learning model architectures have proliferated and have been used to provide solutions for a multitude of prediction problems. Language models (including large language models (LLMs)) are a class of models that learn to generate text, such as natural language. Language models have been used for a variety of solutions, including chat bots, program synthesis, and the like. In program synthesis tasks, the language model attempts to learn to generate computer program code that can be executed (by a computer) to perform a desired task.

Many language models are trained to reply to an input prompt or perform a task (e.g., answering a question or generating program code or other text) in a single turn (i.e., one pass). Other “thinking” models (also referred to as “reasoning” models) use additional tokens to provide additional reasoning expressed in natural language.

### BRIEF SUMMARY

Certain aspects of the present disclosure provide a method for program code synthesis using machine learning. The method generally includes accessing, at a trained generative machine learning model, an input comprising program code with first content; repairing the program code based on processing the input; and outputting the repaired program code from the trained generative machine learning model. Repairing the program code generally includes generating the program code with first content based on processing the input, using the trained generative machine learning model; sending the program code with the first content from the trained generative machine learning model to a text editor for execution of the program code with the first content; receiving, at the trained generative machine learning model from the text editor, an indication of a first state of the program code, the first state comprising the first content of the program code and first feedback from the execution of the program code with the first content; and based on processing the first feedback using the trained generative machine learning model, sending a first editing command from the trained generative machine learning model to the text editor for the text editor to modify the program code with the first content.

Certain aspects of the present disclosure provide a processing system. The processing system generally includes one or more memories comprising processor-executable instructions and one or more processors configured to execute the processor-executable instructions and cause the processing system to: access, at a trained generative machine learning model, an input comprising program code with first content; repair the program code based on processing the input, wherein to repair the program code, the one or more processors are configured to execute the processor-executable instructions and cause the processing system to: send the program code with the first content from the trained generative machine learning model to a text editor for execution of the program code with the first content; receive, at the trained generative machine learning model from the text editor, an indication of a first state of the program code, the first state comprising the first content of the program code and first feedback from the execution of the program code with the first content; and send a first editing command from the trained generative machine learning model to the text editor, based on processing the first feedback using the trained generative machine learning model, for the text editor to modify the program code with the first content; and output the repaired program code from the trained generative machine learning model

Certain aspects of the present disclosure provide a processing system. The processing system generally includes: means for accessing, at a trained generative machine learning model, an input comprising program code with first content; means for repairing the program code based on processing the input, wherein the means for repairing the program code comprises: means for sending the program code with the first content from the trained generative machine learning model to a text editor for execution of the program code with the first content; means for receiving, at the trained generative machine learning model from the text editor, an indication of a first state of the program code, the first state comprising the first content of the program code and first feedback from the execution of the program code with the first content; and means for sending, based on processing the first feedback using the trained generative machine learning model, a first editing command from the trained generative machine learning model to the text editor for the text editor to modify the program code with the first content; and means for outputting the repaired program code from the trained generative machine learning model.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1A illustrates an example machine learning system for multi-turn interactions between a machine learning model and a state tool, according to various aspects of the present disclosure.

FIG. 1B illustrates an example machine learning system for multi-turn interactions between a language model and a text editor for program code synthesis, according to various aspects of the present disclosure.

FIG. 2 depicts example program code generation and repair via multi-turn interactions with a text editor, according to various aspects of the present disclosure.

FIG. 3 is a table of example domain-specific language (DSL) commands, according to various aspects of the present disclosure.

FIG. 4A is a table depicting example corruption types for use in automated generation of a chain-of-edits (CoEs) expert demonstration and corresponding DSL commands that can invert the corruption, according to various aspects of the present disclosure.

FIGS. 4B-1 and 4B-2 illustrate applying and reversing, respectively, an example corruption to a code snippet, according to various aspects of the present disclosure.

FIG. 5 is a flow diagram depicting an example method for program code synthesis using machine learning, according to various aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for improved machine learning. Specifically, some aspects of the present disclosure involve training and operating a relatively small machine learning model to employ inference time computing (ItC) strategies to behave more like a thinking machine learning model (also referred to as a “reasoning” model). Rather than a single pass based on natural language reasoning, such small models may use a multi-turn interaction with a stateful tool. This multi-turn interaction between the language model and the tool may be referred to as “agentic” ItC.

Recent advances have established a new paradigm based on scaling up compute at inference time rather than training time. Via a combination of supervised fine-tuning (SFT) on synthetic demonstrations and reinforcement learning with verifiable rewards (RLVR), capable large language models (LLMs) have been trained to expend extra compute on a given task in the form of “thinking” tokens which take the shape of outlines of step-by-step reasoning expressed in natural language.

According to certain aspects of the present disclosure, these extra tokens may be formatted as a multi-turn interaction with a stateful tool, rather than natural language reasoning. At each turn, the state of the tool is environment-forced into the context of the model, which may then generate the tokens to control the tool via a custom domain-specific language (DSL). This idea may be used to solve the problem of repairing malfunctioning program code (e.g., Python code). In this case, this constrained setup may allow for faster sampling of experience, provide a denser reward signal, and make the task easier overall, allowing language models of relatively smaller sizes (e.g., size≤8 billion parameters) to learn how to proficiently expend additional compute on a task.

Thus, certain aspects of the present disclosure provide techniques and apparatus for inducing ItC-like behavior in a small language model (SLM), in the form of an interaction, over multiple turns, between the SLM and a tool (e.g., a text editor). In some aspects, code (e.g., Python code) can be edited via a custom domain-specific language (DSL) and executed against a set of unit tests to obtain feedback. The structures of the interactions are referred to herein as “chains of edits (CoEs).” For example, the CoE procedure may be applied between a language model (LM) and the tool to pieces of program code that fail to solve a given task. Other use cases for the CoEs include math, logic/reasoning, and sequences of actions. For ease of explanation, the present disclosure focuses on the use case of code repair, with automatically generated code-repair trajectories. Furthermore, certain aspects provide techniques and apparatus to fine-tune SLMs to apply CoEs to the aforementioned code repair scheme, comprising SFT and RLVR stages. The resulting SLMs demonstrate superior performance to their counterparts trained to apply ItC in the form of natural language reasoning traces (e.g., chains of thought (CoTs)).

In some aspects, machine learning models (e.g., language models) can be trained, updated, and/or fine-tuned. As used herein, “fine-tuning” refers to updating the parameter(s) of a machine learning model that has already been at least partially trained (often referred to as a “foundational model”). For example, a model may be trained using one set of data and subsequently fine-tuned for a specific task (e.g., program synthesis) based on a set of fine-tuning data.

As used herein, “repairing” refers to the process of iteratively attempting to produce improved program code. For example, if an initial synthesized program fails to solve or satisfy the task (e.g., because of compilation errors, runtime errors, or errors in the logic of the program), the system may use these errors to prompt the model to generate an updated program (e.g., to attempt to repair the first generated program).

In some aspects, using a coding language model (also referred to as a “program synthesis machine learning model”), the machine learning system generates a code solution (also referred to as a “generated program”) for a programming problem or task. The machine learning system may then attempt to verify or validate the generated program (e.g., using a compiler, using test cases, and/or the like) to decide whether the generated code is accurate (e.g., whether the generated code can be compiled into a valid program that accurately solves or satisfies the desired task).

### Example System for Multi-turn Interactions Between a Machine Learning Model and a State Tool

Most language models (LMs) employing inference time computing (ItC) do so by generating extra tokens in the form of outlines of step-by-step, free-form reasoning, usually referred to as chains of thought (CoTs). These CoTs can be quite lengthy (e.g., thousands of tokens) and may not be structured or constrained in any particular manner.

According to certain aspects of the present disclosure, these extra tokens may be packaged as the tracing of a series of interactions between an LM agent and a stateful environment. The LM agent may alternate between observing the state of the environment and issuing an action, without producing or observing tokens interpretable as free-form reasoning. Such a trace may be referred to herein as a “chain-of-edits (CoE).”

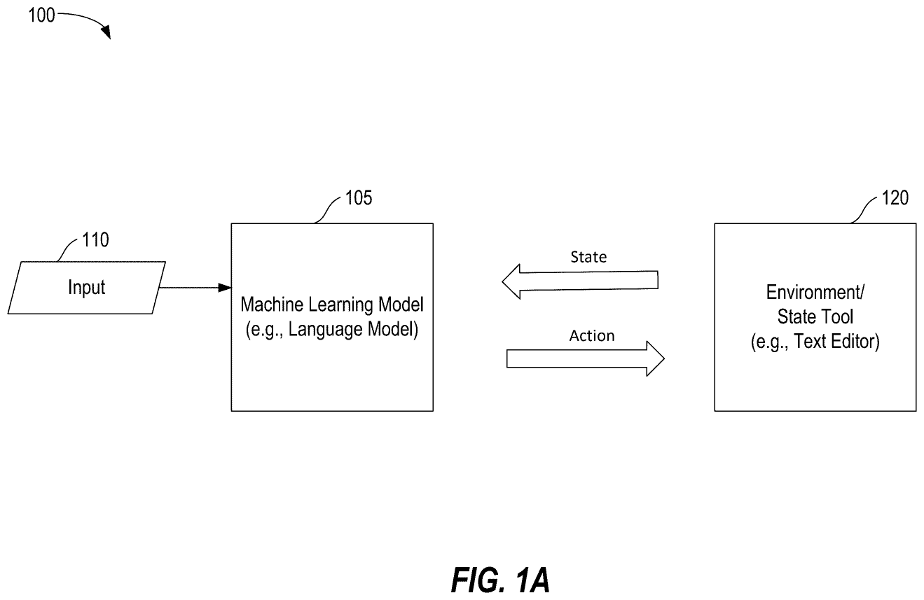

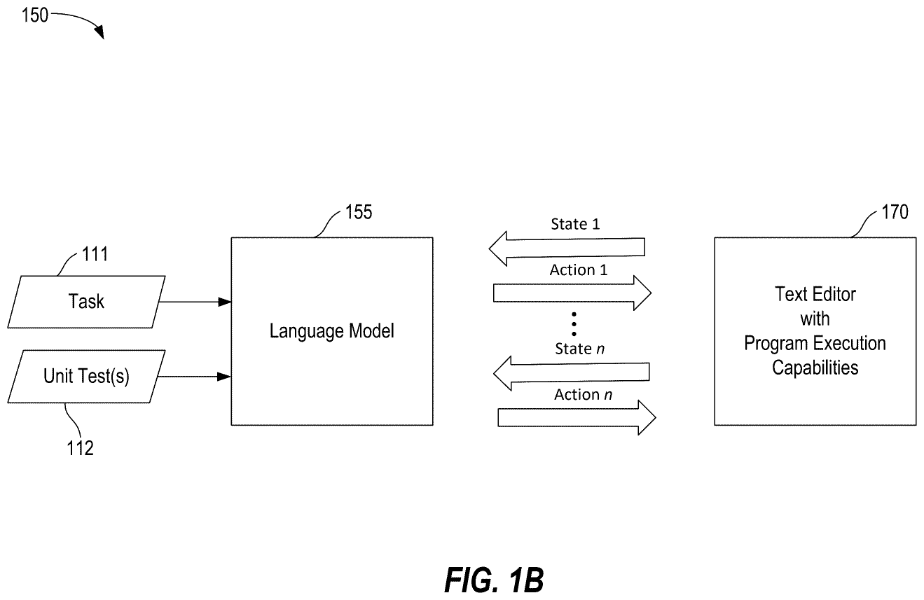

FIG. 1A illustrates an example machine learning system 100 for multi-turn interactions between a machine learning model 105 and an environment/state tool 120, according to various aspects of the present disclosure.

The machine learning model 105 may be implemented as a generative machine learning model, such as a language model. The machine learning model 105 may access an input 110, such as an input prompt. For example, the input prompt may be a query or a description of a task to be performed by the machine learning system 100 (e.g., the machine learning model 105, in conjunction with the environment/state tool 120), such as program code synthesis, a scientific question, a math/logic problem, or speech genesis. As used herein, “accessing” data (e.g., an input prompt or parameters for a model) can generally include receiving, retrieving, requesting, collecting, obtaining, generating, or otherwise gaining access to the data.

The environment/state tool 120 may be a text editor, for example. Such a component is referred to as both an environment and a tool because, like an environment, the environment/state tool 120 has a state (e.g., the program code residing in the editor and the execution feedback resulting from an execution attempt of this code) and like a tool, the environment/state tool 120 is meant to help the machine learning model 105 (referred to as the “agent”) in solving a task, which the model does by taking actions modifying the environment/tool's state. The multi-turn interactions are shown by the arrows labeled “State” and “Action,” where the state is sent from the environment/state tool 120 to the model 105 to convey the current state, and the model 105 responds to the received state with an action (e.g., sending a command) for the environment/state tool 120 to change the state (and provide feedback to the model). This process may be repeated a number of times, hence the term “multi-turn interactions.”

### Example System for Multi-turn Interactions Between a Language Model and a Text Editor

FIG. 1B illustrates an example machine learning system 150 with a language model 155 and a text editor 170 as a specific example supporting program code synthesis with multi-turn interactions, according to certain aspects of the present disclosure.

In some aspects, the language model 155 is a pre-trained machine learning model. In some aspects, the language model 155 has been trained for program synthesis. As discussed above, program synthesis generally corresponds to generation of computer program code that can be compiled and executed to perform a desired task.

As input (e.g., input 110), the language model 155 may receive a task description 111. The task description 111 may include a programming task for the machine learning system 150 to generate program code that can be executed by this or another processing system to perform the task. The task description 111 may include a natural language description (e.g., describing the task in natural language rather than programming language), for example, although any of various other suitable formats may be used (e.g., pseudo-code). For example, the task description 111 may include a prompt such as “write a function to find the first repeated character in a given string.” Additional examples may include, without limitation, prompts such as “write a function to find the longest chain which can be formed from a given set of pairs” or “write a function to get a lucid number smaller than or equal to n.” Generally, the prompts may be of any length, and may include unstructured natural language, as well as other information such as numerical data, structured data, and the like.

In this and other examples, the input to the language model 155 may also include one or more unit tests 112. The unit test(s) 112 may be used to verify the generated program code correctly performs the programming task. For example, continuing the above example programming task to find repeated characters in a string, one unit test 112 may specify that the program should output the character “A” when given the string “ABCABC.” In some aspects, some of these unit tests 112 are hidden (e.g., not provided to the model) and are used to validate the resulting code. The text editor 170 may have code-execution capabilities, and in such cases, the text editor 170 may be used for verification of the generated program code. When all unit tests 112 pass, the programming task may be considered solved.

Part of program code synthesis involves repairing generated code that would malfunction or otherwise perform incorrectly. The multi-turn interactions to generate and repair the program code are shown by the arrows labeled “State” and “Action,” where States 1, 2, . . . n are sent from the text editor 170 to the language model 155 to convey the current state, and the language model 155 responds with Actions 1, 2, . . . n (e.g., code editing commands) for the text editor 170 to modify the program code (and provide feedback to the model). This process may be repeated a number of times, and the number n of interactions may be any integer greater than 1. Although the number of state and action communications are equal in FIG. 1B, the number of state communications need not equal the number of action communications in all cases.

A code repair task may be defined to consist of the following: (i) a natural-language description of a coding task (e.g., the task description 111); (ii) a set of unit tests (e.g., the unit test(s) 112), against which a candidate solution to the task above is supposed to be checked; (iii) a piece of code (e.g., Python code) that fails one or more unit tests (e.g., failure could be due to wrong syntax, inconsistent variable names, or more subtle issues such as lack of alignment with the task's specifications); and (iv) a ground-truth code snippet which solved the task. Therefore, a code repair task is by definition verifiable. For each code repair task, a text editor (e.g., the text editor 170) with verification capabilities is instantiated. At each step in time (e.g., each iteration), the state of the editor is given by the editor's code content followed by the execution feedback gained by running that content against the task's unit tests. The content may be marked with line numbers (which may be helpful for the agent) and a separator (e.g., a sequence of three asterisks “***”) that separates the code content from the subsequent feedback.

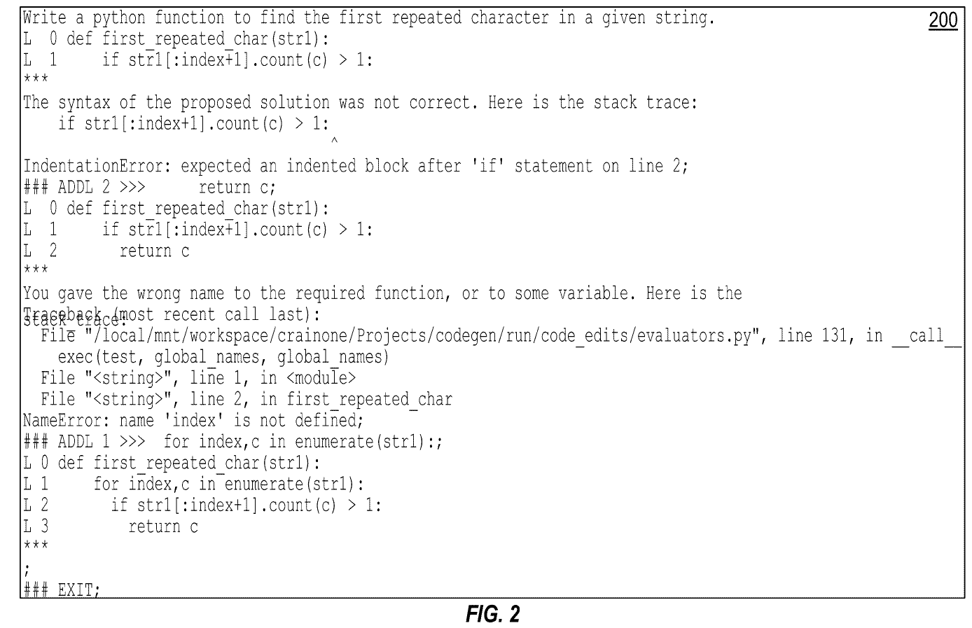

FIG. 2 depicts an example 200 of a chain of edits (CoEs) to the text editor state, after three iterations, according to various aspects of the present disclosure. The text editor state includes a proposed program code and the feedback from executing the proposed code, as described above with respect to the text editor 170 of FIG. 1B. In the example 200, the proposed program code is indicated by line numbers “L0,” “L1,” etc., and a sequence of three asterisks “***” is used as a separator to separator the proposed program code from the execution feedback.

The language model 155 (as an agent) can modify the content of a scratchpad in the text editor 170 by issuing editing commands. The editing commands may be issued in a domain-specific language (DSL), which may be custom designed (e.g., by an operator or a designer of the machine learning system 150). Each time program code is edited, the edited content is executed against the unit test(s) 112, gaining fresh execution feedback and updating the state.

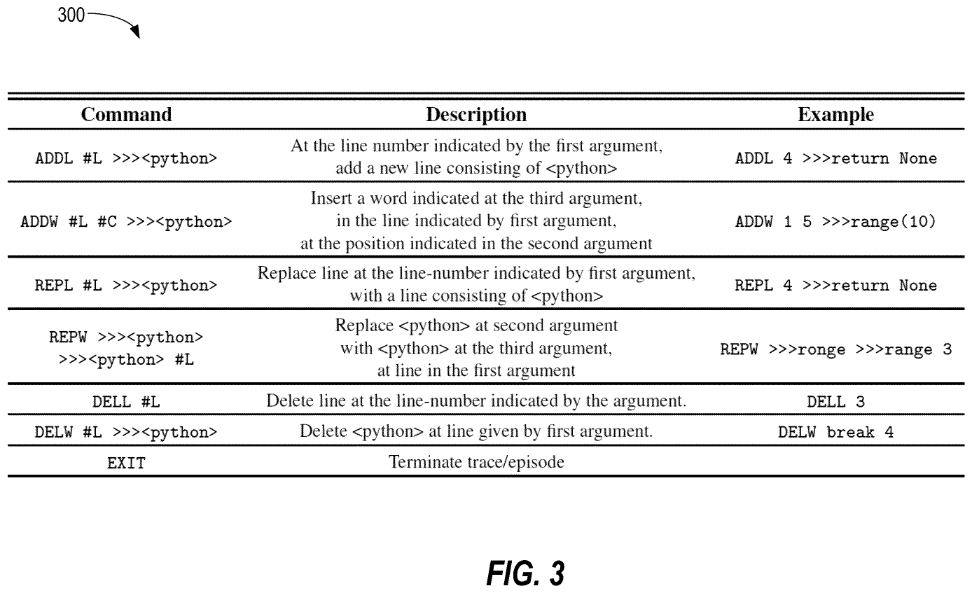

FIG. 3 is a table 300 outlining several DSL commands and providing an example of each, according to certain aspects of the present disclosure. These DSL commands may be used, for example, in the text editor 170 of FIG. 1B.

As can be seen from table 300, the DSL may be designed to encourage small-scale edits to the synthesized program code. Each command may consist of an instruction formatted in uppercase, which can be followed by one or more arguments. For example, the DSL commands may include: (1) adding a line (“ADDL”), adding a word (“ADDW”), replacing a line (“REPL”), replacing a word (“REPW”), deleting a line (“DELL”), deleting a word (“DELW”), and terminating the editing and the associated trace (“EXIT). The arguments may include, for example, a line number (“#L”), a position (“#C”), and code portions (“<python>” for Python code). As a specific example, a DSL command of “ADDW 1 5>>>range (10)” instructs inserting a word “range (10)” indicated at the third argument, in line 1 indicated by the first argument, at the position 5 indicated in the second argument.

Returning to the example 200 of FIG. 2, the DSL editing command “ADDL 2>>>return c” is issued after the first iteration, which adds “return c” as line 2 to the program code. After the second iteration, the DSL editing command “ADDL 1>>>for index, c in enumerate(str1):” is issued, which adds “for index, c in enumerate(str1):” to line 1 of the program code and pushes the other lines of the program code down one line, as shown.

When all unit tests pass and the task is solved, the execution feedback remains empty (e.g., as indicated by the semicolon with no preceding text in the penultimate line of the example 200). When the execution feedback is empty, the language model 155 may issue the DSL command “EXIT,” and the proposed program code used to pass all the tests may be output as the generated program code from the language model 155.

### Example Training for Multi-turn Interactions Between a Language Model and a Text Editor

Having defined the components of a CoE above, training a language model (e.g., the language model 155) to use CoEs may consist of three stages: (1) a run of supervised fine-tuning (SFT) on a single-turn version of a code repair task; (2) multi-turn SFT on a dataset of “expert” demonstrations of CoE usage; and (3) RLVR on the code repair task.

Single-turn SFT may serve to instill a basic understanding of code repair in the language model. In this stage, the model is presented with a snippet of malfunctioning code along with the associated execution feedback, and the model is trained to generate a snippet of repaired code. The input prompt (e.g., the task description 111) may explain in natural language the task that the repaired code is supposed to carry out. The input prompt may also provide a set of unit tests (e.g., unit test(s) 112) that the code should pass. At this stage, the model is trained to generate the correct code in a single pass, without using ItC either in the form of CoTs or CoEs.

Multi-turn SFT may serve to teach the language model how to fix a broken piece of code by interacting with the text editor (e.g., the text editor 170). This stage may be performed by exposing the model to the syntax of the editor's DSL and showing the model how edits relate to the previous state of the code and verifier output. A dataset of synthetic CoE demonstrations may be generated to accomplish this.

One option for generating CoE demonstrations is to train human programmers on DSL usage and have the programmers perform the task of repairing corrupted code snippets by hand. Such a procedure can be expensive and time-consuming by human experts. Another option is an automated pipeline for generating synthetic CoE demonstrations. This pipeline may consist of three steps:
1. Starting from an initial and correct code snippet (e.g., a ground-truth code snippet) for a given task, a corruption that can be inverted by any of the provided DSL commands (e.g., deleting a line) may be (randomly) generated, and this corruption is applied to the code snippet.
2. Step 1 may be repeated any desired number of times c, until the original code snippet is sufficiently corrupted (e.g., after c=C steps, for some C).
3. A CoE demonstration may be created by reversing this process: starting from the corrupted code snippet at step c=C, the applied corruptions are sequentially reversed using the DSL commands. Since the corruptions are invertible by construction, this should ideally recover the original (correct) ground-truth code snippet from step c=0 (before the first corruption).

The CoE demonstration text may be constructed as a sequence of states and actions. A prefix prompt (e.g., the task description 111) may specify the task that the repaired code snippet should perform and may provide a set of unit tests (e.g., the unit test(s) 112) to pass. The prompt may also explain the scratchpad and DSL commands. This is followed by the first state, which contains the fully corrupted code snippet s_{C} (equipped with line markers) and the corresponding execution feedback. The rest of the demonstration consists of a sequence of interleaved DSL commands (actions, such as Actions 2 to n, as shown in FIG. 1B) and scratchpad content with execution feedback (next states, such as States 2 to n, as shown in FIG. 1B) that recovers the original snippet s₀. The final action may be a special EXIT action (as shown in the example 200 of FIG. 2 and the table 300 of FIG. 3) that signals the end of the demonstration.

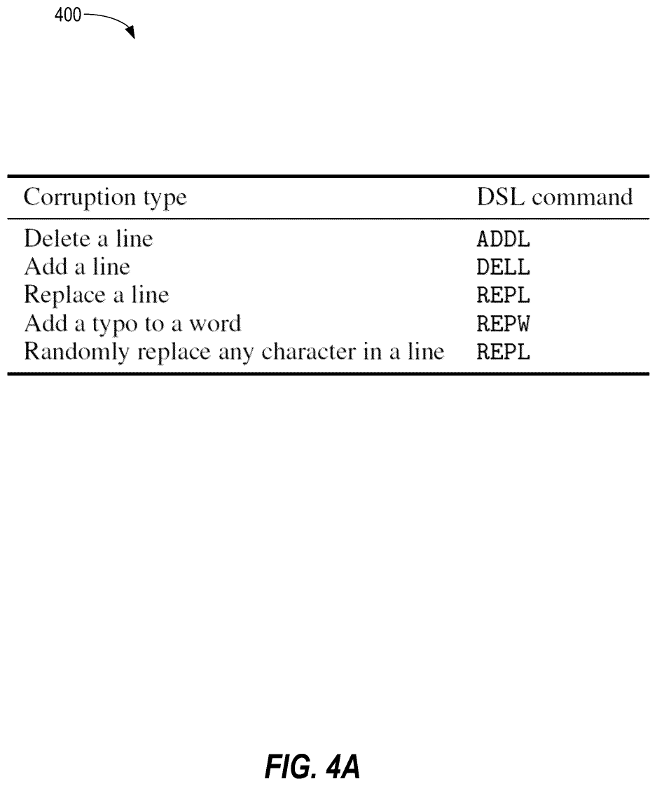

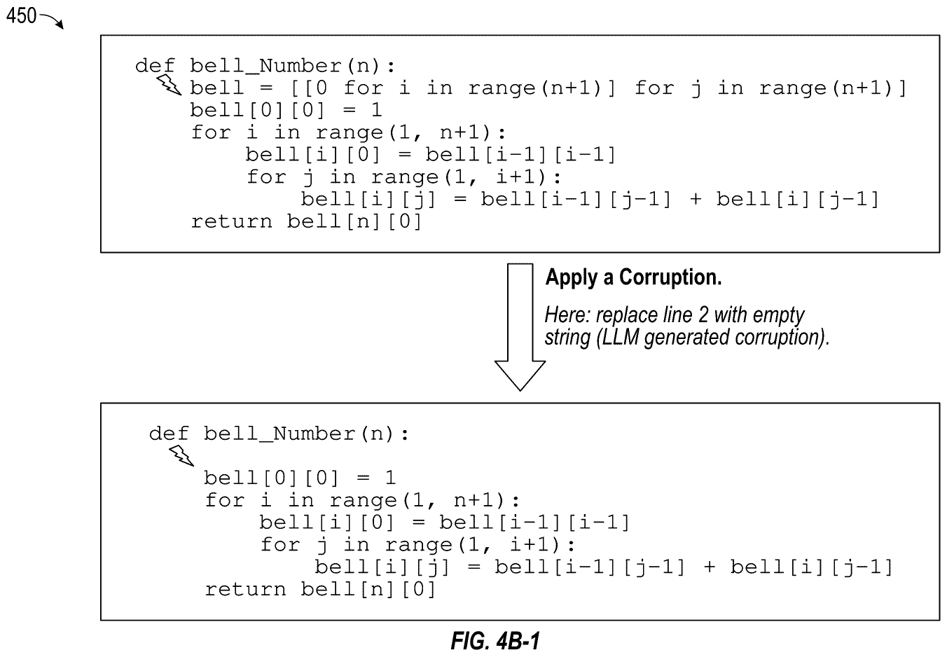

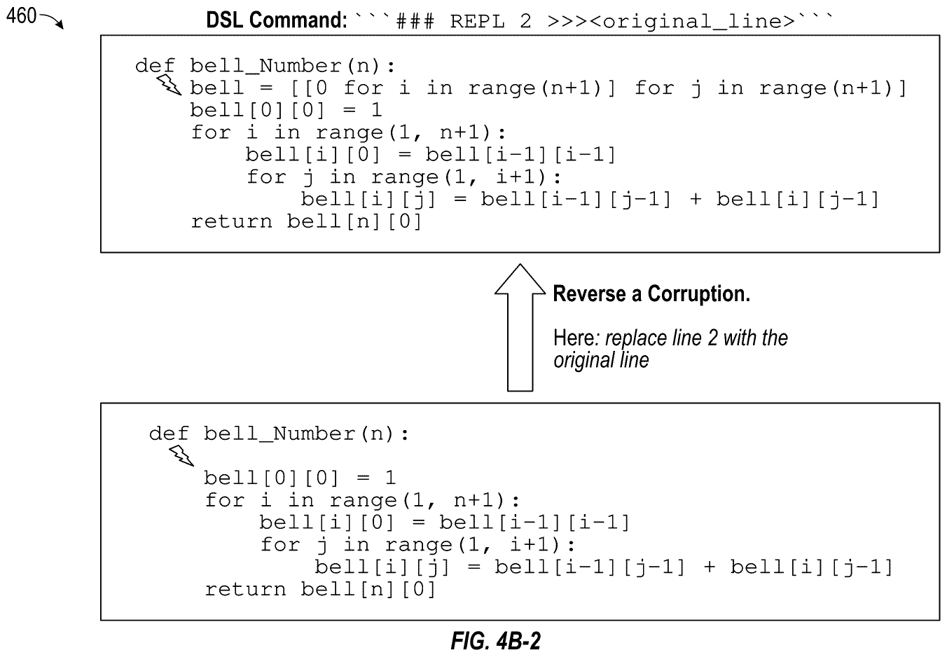

Five types of corruptions may be employed in this CoE demonstration pipeline. Each type of corruption may be matched with a DSL command that can invert this type of corruption, as illustrated in table 400 of FIG. 4A. Some corruptions are reversible by applying multiple DSL commands or a sequence of commands. For example, a corruption that adds a typographical error (also referred to as a “typo”) to a line of code may be inverted by replacing the word that contains the typo or by replacing the entire line with a corrected line. Alternatively, the corruption may be inverted by deleting the offending line and separately adding a corrected line in two steps of DSL interaction. Although every corruption type is matched with a unique DSL command in the table 400 for simplicity, there are other alternatives for matching corruption types with DSL commands.

FIGS. 4B-1 and 4B-2 illustrate applying and reversing, respectively, an example corruption to a code snippet, according to various aspects of the present disclosure. In example 450 of FIG. 4B-1, a replacement corruption is applied, where line 2 of an example code snippet is replaced with an empty string. In example 460 of FIG. 4B-2, this corruption is reversed. Using the DSL command “###REPL 2 >>><original_line>” (according to the syntax in table 300 of FIG. 3), line 2 of the corrupted code snippet is replaced with the line from the original, uncorrupted code snippet (as denoted by “original_line” in the command).

To generate the synthetic dataset, programming tasks and ground-truth code snippets may be taken from an existing dataset, such as from the Mostly Basic Python Problems (MBPP) dataset or the Automated Programming Progress Standard (APPS) dataset. Such datasets generally contain prompts describing a computational task or problem that the generated program should solve or satisfy, as well as one or more samples of program code (e.g., authored by human programmers) that solve or perform the task. For each task in the dataset, the total number of corruptions (e.g., between 1 and 5 (inclusive)) may be sampled, and then that many corruption types with replacement may be uniformly sampled. To obtain diverse CoE trajectories, this procedure may be repeated a number of times (e.g., in the train split of MBPP) and a fewer number of times each in the validation dataset. This leads to a dataset of numerous demonstrations for training and for validation after de-duplication. The models may then be fine-tuned to imitate these demonstrations, for example, with supervised fine-tuning using low-rank adaptation (LoRA).

Now that the language model has learned to use the text editor, RLVR may be employed on the final code-repair task, per the third step of training the model outlined above. Here, the programming tasks may be the same as those used during the single-turn SFT stage, but now the model may be prompted to use the multi-turn CoE procedure to solve the tasks, rather than to directly generate the repaired code snippet in a single pass. As in the multi-turn SFT stage, the prompt may describe the task and outline usage of the scratchpad and the DSL commands. This prompt may be followed by the initial state (e.g., State 1), which contains the broken code snippet (equipped with line markers) and this snippet's corresponding execution feedback. A suitable reinforcement learning (RL) procedure may be employed during this step. When sampling experience, the model may be prompted with the whole CoE so far (e.g., all states and actions) and may output an action in the form of an editing command. This action is executed in the scratchpad of the text editor and rewarded using a verifiable reward function. The resulting experience may be stored in a buffer and trained on an objective (e.g., a group relative policy objective (GRPO).

An example verifiable reward function may consist of task reward and format reward terms. Example task rewards may include the following:
OnlyWhenSolved: the reward is high (e.g., 1.0) if and only if the task is solved in the current turn and was not solved in the previous turn;
UnitTestFraction: the reward is the change in the fraction of unit tests solved between the current turn and the last turn; and/or
UnitTestFraction+EditDistanceBonus: the reward is that of UnitTestFraction plus a bonus/penalty if the current code snippet looks more/less like the ground-truth snippet than in the previous turn.

In some aspects, the format reward term may apply a penalty (e.g., of −1.0) when the model outputs an action that does not contain the correct DSL delimiters. Additionally, the language model may be penalized when the model does not output an EXIT action after the code snippet has been repaired (e.g., passes all unit tests).

During an example of training and evaluation, models trained to output CoEs may be coupled with the editor. Every time the model generates an action, the action may be executed by the scratchpad, and the verifier may return execution feedback from running the unit tests on the resulting code snippet. The snippet resulting from the action and the new execution feedback form the next state. This state is added to the existing state action sequence and placed in model context. This way, the model is provided with the state externally and observes accurate execution feedback at each step. The model may run for a maximum number of turns, and the context size may be limited to a particular number of tokens.

### Example Method for Program Code Synthesis Using Machine Learning

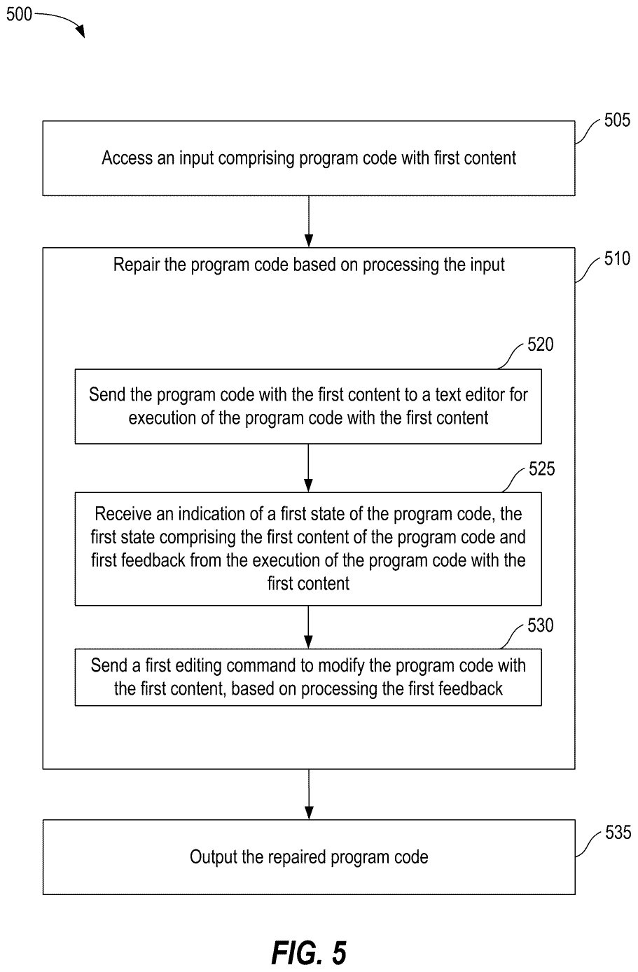

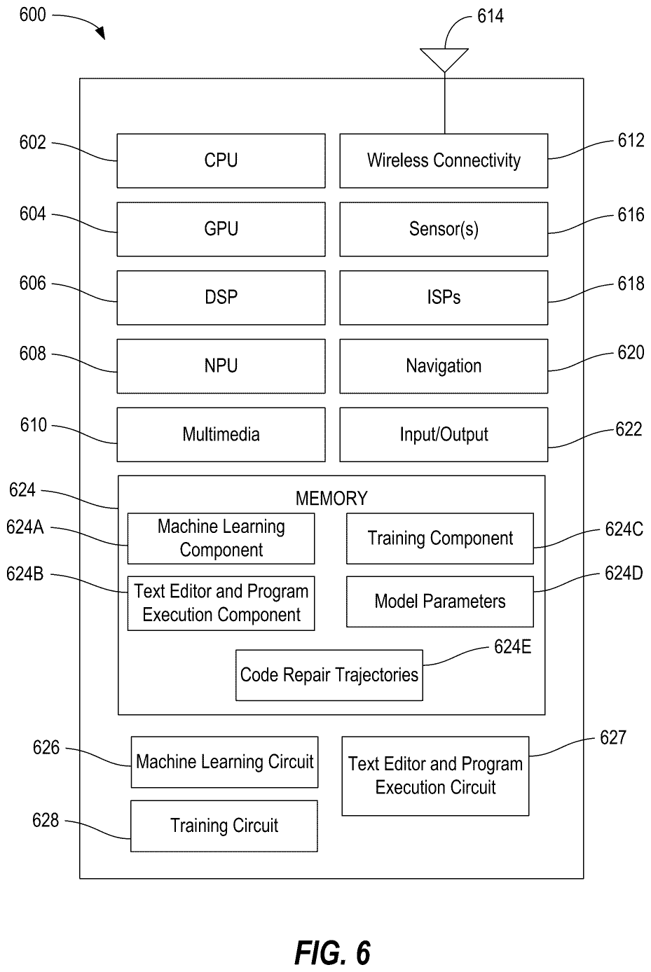

FIG. 5 is a flow diagram depicting an example method 500 for generating and repairing program code using machine learning, according to various aspects of the present disclosure. In some aspects, the method 500 is performed by or using a machine learning model, such as the machine learning model 105 of FIG. 1A or the language model 155 of FIG. 1B. In some aspects, the method 500 is performed by a processing system, such as the processing system of FIG. 6.

At block 505, an input (e.g., input 110 or task description 111) including program code with first content is accessed. This input may be accessed at a trained generative machine learning model, such as a trained language model (e.g., language model 155).

At block 510, program code is repaired based on processing the input. The repairing of the program code at block 510 may be performed, at least in part, by the trained machine learning model, which may communicate with a text editor (e.g., the text editor 170 of FIG. 1B). Repairing the program code at block 510 may involve several processes.

At block 520, the program code program code with the first content is sent or otherwise provided to a text editor for execution of the program code with the first content. At block 525, an indication of a first state (e.g., State 1) of the program code is received. The first state of the program code may include and/or indicate the first content of the program code and first feedback from the execution of the program code with the first content. The first state may be received at the trained generative machine learning model from the text editor. In some aspects, the first feedback includes an indication that the program code with the first content is incorrect.

At block 530, a first editing command (e.g., as Action 1) is sent to the text editor for the text editor to modify the program code with the first content. This first editing command may be sent from the trained generative machine learning model based on processing the first feedback using the trained generative machine learning model.

At block 535, the repaired program code is output. The repaired program code may be used by a computing device (e.g., the processing system 600 of FIG. 6), which may be the same or a different computing device than the device that generated the program code.

The program code may be originally generated using the trained generative machine learning model, for example. In other examples, the program code may be originally generated by a different model or provided as input, for example, by a human operator.

In some aspects, the program code modified by the text editor has second content. In this case, repairing the program code at block 510 may further involve receiving an indication of a second state (e.g., State 2) of the program code. The second state may include the second content of the program code and second feedback from the execution of the program code with the second content. The indication of the second state may be received at the trained generative machine learning model from the text editor.

According to certain aspects, another input indicating a programming task may be accessed (e.g., by the model). In this case, the repaired program code is output at block 535 based on the second feedback, and the second feedback may indicate verification of the program code with the second content for performing the programming task.

In some aspects, repairing the program code at block 510 further involves, a second editing command being sent (e.g., from the trained generative machine learning model) to the text editor. The second editing command may include an instruction (e.g., EXIT) for the text editor to terminate the repairing of the program code. Sending the second editing command may be based on processing the second feedback (e.g., empty feedback) using the trained generative machine learning model.

According to certain aspects, repairing the program code at block 510 further involves a second editing command being sent (e.g., from the trained generative machine learning model) to the text editor for the text editor to modify the program code with the second content. The modified program code may have third content. Sending the second editing command may be based on processing the second feedback using the trained generative machine learning model. In some aspects, an indication of a third state (e.g., State 3) of the program code may be received from the text editor. The indication of the third state may be received at the trained generative machine learning model from the text editor. The third state may include and/or indicate the third content of the program code and third feedback from the execution of the program code with the third content.

According to certain aspects, the first editing command comprises a domain-specific language (DSL) command. In some aspects, the first editing command includes an instruction (e.g., ADDL) for the text editor to add a first line to the program code with the first content, an instruction (e.g., DELL) for the text editor to delete a second line from the program code with the first content, or an instruction (e.g., REPL) for the text editor to replace a third line of the program code with the first content with a fourth line. In other aspects, the first editing command includes an instruction (e.g., ADDW) for the text editor to add a first word to the program code with the first content, an instruction (e.g., DELW) for the text editor to delete a second word from the program code with the first content, or an instruction (e.g., REPW) for the text editor to replace a third word of the program code with the first content with a fourth word.

According to certain aspects, an indication of a programming task (e.g., the task description 111 of FIG. 1B) may be accessed (e.g., by the trained model). In some aspects, the indication comprises a natural language description of the programming task. In some aspects, the same or a different input is accessed and includes a set of unit tests (e.g., the set of unit tests 112 of FIG. 1B) to verify accuracy of programs with respect to the programming task.

### Example Processing System for Program Synthesis Using Machine Learning Models

In some aspects, the workflows, techniques, and methods described with reference to FIGS. 1A-5 may be implemented on one or more devices or systems. FIG. 6 depicts an example processing system 600 configured to perform various aspects of the present disclosure, including, for example, the techniques and methods described with respect to FIGS. 1A-5. In some aspects, the processing system 600 may correspond to a machine learning system, such as the machine learning system 100 of FIG. 1A or the machine learning system 150 of FIG. 1B. Generally, the processing system 600 may correspond to any computing system that implements machine learning models. Although depicted as a single system for conceptual clarity, in some aspects, as discussed above, the operations described below with respect to the processing system 600 may be distributed across any number of devices or systems.

The processing system 600 includes a central processing unit (CPU) 602, which in some examples may be a multi-core CPU. Instructions executed at the CPU 602 may be loaded, for example, from a program memory associated with the CPU 602 or may be loaded from a memory partition (e.g., a partition of memory 624).

The processing system 600 also includes additional processing components tailored to specific functions, such as a graphics processing unit (GPU) 604, a digital signal processor (DSP) 606, a neural processing unit (NPU) 608, a multimedia component 610 (e.g., a multimedia processing unit), and a wireless connectivity component 612.

An NPU, such as NPU 608, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 608 is a part of one or more of the CPU 602, the GPU 604, and/or the DSP 606.

In some examples, the wireless connectivity component 612 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 612 is further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS), as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes the memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a machine learning component 624A, a text editor and program execution component 624B, and a training component 624C. The memory 624 further includes model parameters 624D for one or more models or portions thereof (e.g., parameters of a machine learning model, such as the machine learning model 105 of FIG. 1A or the language model 155 of FIG. 1B). The memory 624 may also store code repair trajectories 624E (which may correspond to the chain of edits (CoEs) described above). Although not included in the illustrated example, in some aspects the memory 624 may also include other data, such as training data (e.g., task descriptions, unit tests, and/or program code solutions). Though depicted as discrete components for conceptual clarity in FIG. 6, the illustrated components (and others not depicted) may be collectively or individually implemented in various aspects.

The processing system 600 further comprises a machine learning circuit 626, a text editor and program execution circuit 627, and a training circuit 628. The depicted circuits, and others not depicted, may be configured to perform various aspects of the techniques described herein.

For example, the machine learning component 624A and/or the machine learning circuit 626 may be used to generate synthesized programs using machine learning models, as discussed above. For example, the machine learning component 624A and/or the machine learning circuit 626 may process input text, such as task descriptions (e.g., the task descriptions 111 and/or the unit test(s) 112 of FIG. 1B) using machine learning models (e.g., the machine learning model 105 of FIG. 1A and/or the language model 155 of FIG. 1B) to generate synthesized programs. In some aspects, the machine learning component 624A and/or the machine learning circuit 626 may similarly generate updated prompts (e.g., by concatenating task descriptions (such as the task description 111 of FIG. 1B), incorrect programs, and/or feedback. The machine learning component 624A and/or the machine learning circuit 626 may then use these updated prompts to generate revised models.

Though depicted as separate components and circuits for clarity in FIG. 6, the machine learning circuit 626, the text editor and program execution circuit 627, and the training circuit 628 may collectively or individually be implemented in other processing devices of the processing system 600, such as within the CPU 602, the GPU 604, the DSP 606, the NPU 608, and the like.

Generally, the processing system 600 and/or components thereof may be configured to perform the methods described herein.

Notably, in other aspects, elements of the processing system 600 may be omitted, such as where the processing system 600 is a server computer or the like. For example, the multimedia component 610, the wireless connectivity component 612, the sensor processing units 616, the ISPs 618, and/or the navigation processor 620 may be omitted in other aspects. Further, aspects of the processing system 600 may be distributed between multiple devices.

### Example Clauses

Implementation examples are described in the following numbered clauses:
Clause 1: A processor-implemented method for program code synthesis using machine learning, the method comprising: accessing, at a trained generative machine learning model, an input comprising program code with first content; repairing the program code based on processing the input, wherein repairing the program code comprises: sending the program code with the first content from the trained generative machine learning model to a text editor for execution of the program code with the first content; receiving, at the trained generative machine learning model from the text editor, an indication of a first state of the program code, the first state comprising the first content of the program code and first feedback from the execution of the program code with the first content; and based on processing the first feedback using the trained generative machine learning model, sending a first editing command from the trained generative machine learning model to the text editor for the text editor to modify the program code with the first content; and outputting the repaired program code from the trained generative machine learning model.
Clause 2: The processor-implemented method according to Clause 1, wherein: the modified program code has second content; and repairing the program code further comprises receiving, at the trained generative machine learning model from the text editor, an indication of a second state of the program code, the second state comprising the second content of the program code and second feedback from the execution of the program code with the second content.
Clause 3: The processor-implemented method according to Clause 2, further comprising accessing, at the trained generative machine learning model, another input indicating a programming task, wherein: outputting the repaired program code is based on the second feedback; and the second feedback indicates verification of the program code with the second content for performing the programming task.
Clause 4: The processor-implemented method according to Clause 3, wherein repairing the program code further comprises, based on processing the second feedback using the trained generative machine learning model, sending a second editing command from the trained generative machine learning model to the text editor, wherein the second editing command comprises an instruction for the text editor to terminate the repairing of the program code.
Clause 5: The processor-implemented method according to Clause 2, wherein repairing the program code further comprises: based on processing the second feedback using the trained generative machine learning model, sending a second editing command from the trained generative machine learning model to the text editor for the text editor to modify the program code with the second content, the modified program code having third content; and receiving, at the trained generative machine learning model from the text editor, an indication of a third state of the program code, the third state comprising the third content of the program code and third feedback from the execution of the program code with the third content.
Clause 6: The processor-implemented method according to any of the preceding Clauses, wherein the first editing command comprises a domain-specific language (DSL) command.
Clause 7: The processor-implemented method according to any of the preceding Clauses, wherein the first editing command comprises an instruction for the text editor to add a first line to the program code with the first content, an instruction for the text editor to delete a second line from the program code with the first content, or an instruction for the text editor to replace a third line of the program code with the first content with a fourth line.
Clause 8: The processor-implemented method according to any of Clauses 1 to 6, wherein the first editing command comprises an instruction for the text editor to add a first word to the program code with the first content, an instruction for the text editor to delete a second word from the program code with the first content, or an instruction for the text editor to replace a third word of the program code with the first content with a fourth word.
Clause 9: The processor-implemented method according to any of the preceding Clauses, further comprising accessing, at the trained generative machine learning model, an indication of a programming task, wherein the indication comprises a natural language description of the programming task.
Clause 10: The processor-implemented method according to any of the preceding Clauses, further comprising accessing, at the trained generative machine learning model, an indication of a programming task, wherein another input comprises a set of unit tests to verify accuracy of programs with respect to the programming task.
Clause 11: The processor-implemented method according to any of the preceding Clauses, wherein the first feedback comprises an indication that the program code with the first content is incorrect.
Clause 12: A processing system comprising: memory comprising computer-executable instructions; and one or more processors coupled to the memory and configured to execute the computer-executable instructions and cause the processing system to perform a method in accordance with any of Clauses 1-11.

Clause 13: A mobile device comprising the processing system of Clause 12.

Clause 14: A processing system comprising means for performing a method in accordance with any of Clauses 1-11.

Clause 15: A non-transitory computer-readable medium comprising computer-executable instructions that, when executed by one or more processors of a processing system, cause the processing system to perform a method in accordance with any of Clauses 1-11.

Clause 16: A computer program product embodied on a computer-readable storage medium comprising code for performing a method in accordance with any of Clauses 1-11.

### Additional Considerations

Certain aspects of the present disclosure enable small language models to solve code repair tasks step-by-step without the complexity and verbosity of chains of thought (CoTs). In this sense, CoEs may function as a constrained, agentic counterpart of CoTs.

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented, or a method may be practiced, using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
one or more memories comprising processor-executable instructions; and
one or more processors configured to execute the processor-executable instructions and cause the processing system to:
access, at a trained generative machine learning model, an input comprising program code with first content;
repair the program code based on processing the input, wherein to repair the program code, the one or more processors are configured to execute the processor-executable instructions and cause the processing system to:
send the program code with the first content from the trained generative machine learning model to a text editor for execution of the program code with the first content;
receive, at the trained generative machine learning model from the text editor, an indication of a first state of the program code, the first state comprising the first content of the program code and first feedback from the execution of the program code with the first content; and
send a first editing command from the trained generative machine learning model to the text editor, based on processing the first feedback using the trained generative machine learning model, for the text editor to modify the program code with the first content; and
output the repaired program code from the trained generative machine learning model.

2. The processing system of claim 1, wherein:
the modified program code has second content;
to repair the program code, the one or more processors are configured to execute the processor-executable instructions and further cause the processing system to receive, at the trained generative machine learning model from the text editor, an indication of a second state of the program code; and
the second state comprises the second content of the program code and second feedback from the execution of the program code with the second content.

3. The processing system of claim 2, wherein:
the one or more processors are configured to execute the processor-executable instructions and further cause the processing system to access, at the trained generative machine learning model, another input indicating a programming task;
to output the repaired program code, the one or more processors are configured to execute the processor-executable instructions and cause the processing system to output the repaired program code based on the second feedback; and
the second feedback indicates verification of the program code with the second content for performing the programming task.

4. The processing system of claim 3, wherein:
to repair the program code, the one or more processors are configured to execute the processor-executable instructions and further cause the processing system to send a second editing command from the trained generative machine learning model to the text editor based on processing the second feedback using the trained generative machine learning model; and
the second editing command comprises an instruction for the text editor to terminate repair of the program code.

5. The processing system of claim 2, wherein to repair the program code, the one or more processors are configured to execute the processor-executable instructions and further cause the processing system to:
send, based on processing the second feedback using the trained generative machine learning model, a second editing command from the trained generative machine learning model to the text editor for the text editor to modify the program code with the second content, the modified program code having third content; and
receive, at the trained generative machine learning model from the text editor, an indication of a third state of the program code, the third state comprising the third content of the program code and third feedback from the execution of the program code with the third content.

6. The processing system of claim 1, wherein the first editing command comprises a domain-specific language (DSL) command.

7. The processing system of claim 1, wherein the first editing command comprises an instruction for the text editor to add a first line to the program code with the first content, an instruction for the text editor to delete a second line from the program code with the first content, or an instruction for the text editor to replace a third line of the program code with the first content with a fourth line.

8. The processing system of claim 1, wherein the first editing command comprises an instruction for the text editor to add a first word to the program code with the first content, an instruction for the text editor to delete a second word from the program code with the first content, or an instruction for the text editor to replace a third word of the program code with the first content with a fourth word.

9. The processing system of claim 1, wherein the one or more processors are configured to execute the processor-executable instructions and further cause the processing system to access, at the trained generative machine learning model, an indication of a programming task and wherein the indication comprises a natural language description of the programming task.

10. The processing system of claim 1, wherein the one or more processors are configured to execute the processor-executable instructions and further cause the processing system to access, at the trained generative machine learning model, an indication of a programming task and wherein another input comprises a set of unit tests to verify accuracy of programs with respect to the programming task.

11. The processing system of claim 1, wherein the first feedback comprises an indication that the program code with the first content is incorrect.

12. A mobile device comprising the processing system of claim 1.

13. A processor-implemented method for program code synthesis using machine learning, the method comprising:
accessing, at a trained generative machine learning model, an input comprising program code with first content;
repairing the program code based on processing the input, wherein repairing the program code comprises:
sending the program code with the first content from the trained generative machine learning model to a text editor for execution of the program code with the first content;
receiving, at the trained generative machine learning model from the text editor, an indication of a first state of the program code, the first state comprising the first content of the program code and first feedback from the execution of the program code with the first content; and
based on processing the first feedback using the trained generative machine learning model, sending a first editing command from the trained generative machine learning model to the text editor for the text editor to modify the program code with the first content; and
outputting the repaired program code from the trained generative machine learning model.

14. The processor-implemented method of claim 13, wherein:
the modified program code has second content; and
repairing the program code further comprises receiving, at the trained generative machine learning model from the text editor, an indication of a second state of the program code, the second state comprising the second content of the program code and second feedback from the execution of the program code with the second content.

15. The processor-implemented method of claim 14, further comprising accessing, at the trained generative machine learning model, another input indicating a programming task, wherein:
outputting the repaired program code is based on the second feedback; and
the second feedback indicates verification of the program code with the second content for performing the programming task.

16. The processor-implemented method of claim 15, wherein repairing the program code further comprises, based on processing the second feedback using the trained generative machine learning model, sending a second editing command from the trained generative machine learning model to the text editor, wherein the second editing command comprises an instruction for the text editor to terminate the repairing of the program code.

17. The processor-implemented method of claim 14, wherein repairing the program code further comprises:
based on processing the second feedback using the trained generative machine learning model, sending a second editing command from the trained generative machine learning model to the text editor for the text editor to modify the program code with the second content, the modified program code having third content; and
receiving, at the trained generative machine learning model from the text editor, an indication of a third state of the program code, the third state comprising the third content of the program code and third feedback from the execution of the program code with the third content.

18. The processor-implemented method of claim 13, wherein the first editing command comprises an instruction for the text editor to:
add a first line to the program code with the first content;
delete a second line from the program code with the first content;
replace a third line of the program code with the first content with a fourth line;
add a first word to the program code with the first content;
delete a second word from the program code with the first content; or
replace a third word of the program code with the first content with a fourth word.

19. The processor-implemented method of claim 13, further comprising accessing, at the trained generative machine learning model, an indication of a programming task, wherein the indication comprises a natural language description of the programming task.

20. The processor-implemented method of claim 13, further comprising accessing, at the trained generative machine learning model, an indication of a programming task, wherein another input comprises a set of unit tests to verify accuracy of programs with respect to the programming task.
